(19) United States
(12) Patent Application Publication
(10) Pub. No.: US 2005/0201233 A1
(43) Pub. Date: Sep. 15, 2005

(54) Optical storage medium reading apparatus and method thereof

(76) Inventor: Wu-Sung Lee, Taoyang (TW)

Correspondence Address: THOMAS, KAYDEN, HORSTEMEYER & RISLEY, LLP, 100 GALLERIA PARKWAY, NW, STE 1750, ATLANTA, GA, 30339-5948, US

(21) Appl. No.: 10/912,343

(22) Filed: Aug. 5, 2004

(30) Foreign Application Priority Data
Mar. 12, 2004 (TW) 93106635

(51) Int. Cl. G11B 5/09

(52) U.S. Cl. 369/47.36; 369/53.31

(57) ABSTRACT

An optical storage medium reading apparatus and method thereof. A reading component is driven by a mechanical device, reading data from an optical storage medium. A control unit acquires a first error value after the mechanical device reads data from an inner to an outer region on the optical storage medium, and acquires a second error value after the mechanical device reads the same data. In addition, the control unit adjusts rotation of the mechanical device if the difference between the first error value and the second error value exceeds a difference threshold.

### BACKGROUND OF THE INVENTION

1. Field of the Invention

The present invention relates to an optical reading apparatus, and more particularly, to an optical storage medium reading apparatus and method thereof providing reduced optical storage medium breakage.

2. Description of the Related Art

Conventional optical storage media, such as CD, CD-RW, DVD, DVD−RW, DVD+RW, SACD, or other disc type, are normally made of plastic. Fissures often occur on optical storage media during improper manufacture or usage or under variations in temperature, resulting in disc breakage when applied at high rotational speeds. With rapidly higher rotation speeds in optical storage devices, prevention of disc breakage has become increasingly important.

Although conventional optical storage devices utilize mechanical devices, such as loading covers, to prevent broken discs from escaping, the broken discs can damage the entire optical device. In view of the above, a need exists for an optical storage medium reading apparatus thereof providing reduced optical storage medium breakage.

### SUMMARY OF THE INVENTION

It is therefore an object of the present invention to provide an optical storage medium reading apparatus thereof providing reduced optical storage medium breakage. A reading apparatus and method thereof accordingly periodically detect the variation in error counts from an optical storage medium, and stops or slows rotation speed when a fissure or scratch is detected.

A reading apparatus of an embodiment of the invention comprises a reading component, a mechanical device and a control unit. The reading component is driven by the mechanical device, and reads data from the optical storage medium. The control unit performs two processing steps after receiving an initial signal from the mechanical device. In the first processing step, the control unit acquires a first error value after the mechanical device reads a portion of data from an inner to an outer region of the optical storage medium. In the second processing step, the control unit acquires a second error value after the mechanical device reads the same portion of data.

Preferably, the second processing step is performed after a predetermined period of time has passed, and when the mechanical device is idle. The first error value represents a count of error codes acquired during the first processing step; the second error value represents a count of error codes acquired during the second processing step. Both the first error value and the second error value represent a random error count or a burst error count. Preferably, the random error count corresponds to a C1 value for Reed-Solomon codes, and the burst error count corresponds to a C2 value for Reed-Solomon codes.

The control unit adjusts rotation speed of the mechanical device if the first error value exceeds an initial threshold or the difference between the first error value and the second error value exceeds a difference threshold. The adjustment of rotation speed comprises stop of the mechanical device or slow down of the mechanical device.

A method is further introduced to reduce optical storage medium breakage at high rotation speeds in the reading apparatus. The method comprises receiving an initial signal from the mechanical device, acquiring a first error value after a portion of data from an inner to an outer region on the optical storage medium is read, acquiring a second error value after the portion of data on the optical storage medium is read, and adjusting rotation speed of the mechanical device when the difference between the first error value and the second error value exceeds a difference threshold. The method further comprises adjustment rotation speed of the mechanical device when the first error value exceeds an initial threshold.

### BRIEF DESCRIPTION OF THE DRAWINGS

The present invention can be more fully understood by reading the subsequent detailed description and examples with references made to the accompanying drawings, wherein:

FIG. 1 shows a reading apparatus according to an embodiment of the invention;

FIGS. 2a and 2b are flowcharts of a reading method according to an embodiment of the present invention.

### DETAILED DESCRIPTION OF THE INVENTION

Optical storage medium breakage often occurs from the inside out. Thus, periodic detection of variations in error numbers via reading the innermost data enables a reading apparatus to determine whether a fissure is present. The reading apparatus stops or slows rotation to prevent disc breakage when a fissure is detected.

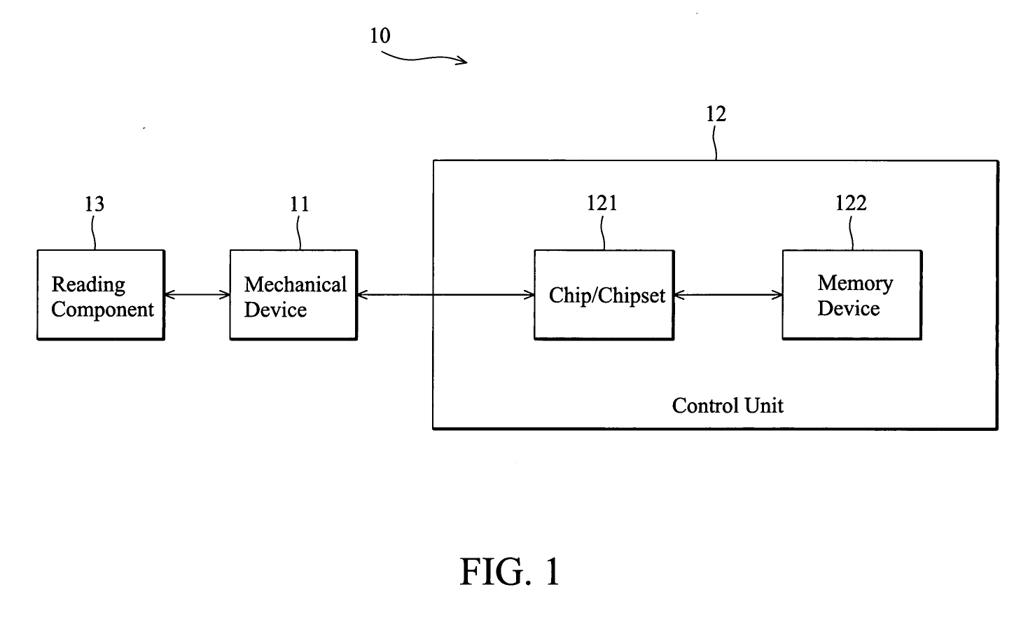

FIG. 1 shows a reading apparatus according to an embodiment of the invention. The reading apparatus 10 comprises a mechanical device 11, a control unit 12 and a reading component 13. The reading component 13 comprises a pickup head (not shown), reading data from an optical storage medium. The mechanical device 11 comprises a rotary motor (not shown), operating during data read. The control unit 12 comprises a chip/chipset 121 and a memory device 122. The memory device 122 is preferably non-volatile, such as a ROM, an EEPROM, a flash ROM, or other memory device retaining data after power-down. The reading component 13, mechanical device 11 and the control unit 12 are essential parts of a conventional reading apparatus, such as a CD-ROM drive, a CD-RW drive, a DVD-ROM drive, a DVD+RW drive, a DVD−RW drive, a SACD drive, or others.

The chip/chipset 121 comprises data read logic, data decode logic and rotation speed control logic. The data read logic directs the reading component 13 to read within a given range (usually in Logical Black Address, LBA) of data from an optical storage medium. The data is encoded (preferably are Reed-Solomon codes, R-S codes), comprising error correction codes (ECCs). The data decode logic receives encoded data from the data read logic, validates and corrects (if required) the encoded data according to the ECCs, and outputs revised data and an error count representing a random error count or a burst error count. Preferably, the random error count corresponds to a C1 value for R-S codes, and the burst error count corresponds to a C2 value for R-S codes. The rotation speed control logic directs the mechanical device 11 to stop or slow rotation.

The control unit 12 performs two processing steps after receiving an initial signal from the mechanical device 11. In the first processing step, the control unit 12 reads a portion of data from the innermost region on the optical storage medium by executing the data read logic, and acquires a first error value by executing the data decode logic. In the second processing step, the control unit 12 reads the same data by executing the data read logic, and acquires a second error value by executing the data decode logic.

The second processing step is performed after a predetermined period of time has passed, and when the mechanical device 11 is idle. The first error value represents the number of error codes generated during the first processing step, and the second error value represents the number of error codes generated during the second processing step. The first error value and the second error value may be a random error count or a burst error count. Preferably, the random error count corresponds to a C1 value for R-S codes, and the burst error count corresponds to a C2 value for R-S codes.

If the first error value exceeds an initial threshold, or the difference between the first error value and the second error value exceeds a difference threshold, the control unit 12 adjusts rotation speed of the mechanical device 11 by executing the rotation control logic, reducing disc breakage at high rotation speeds. Adjustment of rotation speed either stops the mechanical device 11 or slows rotation thereof.

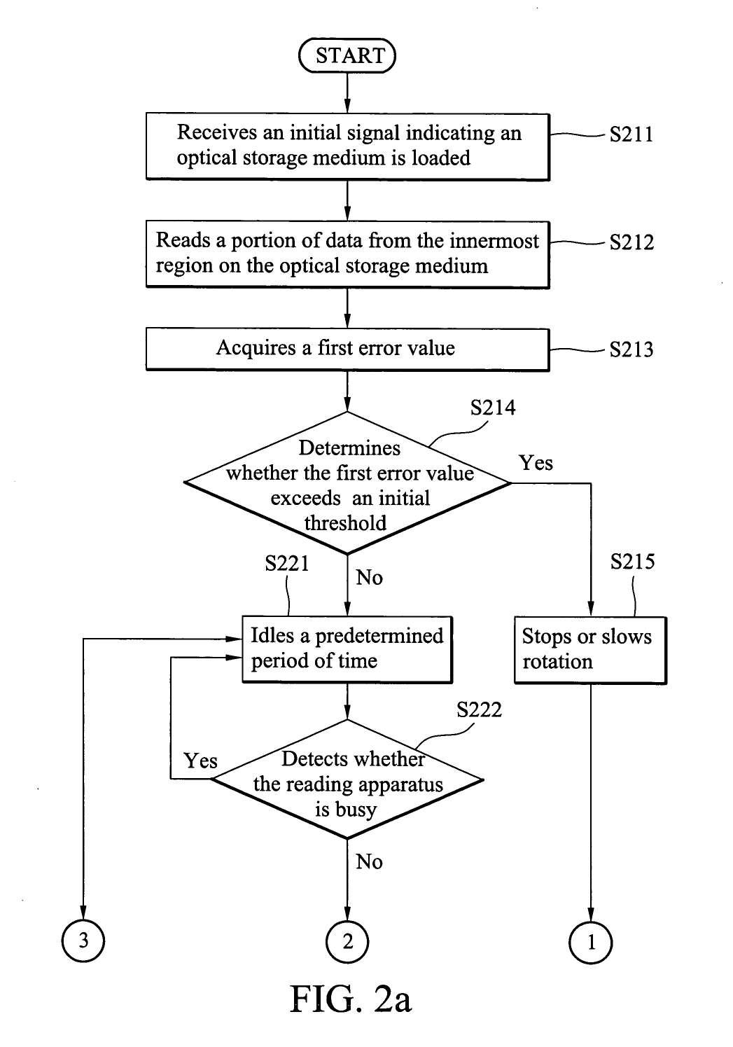

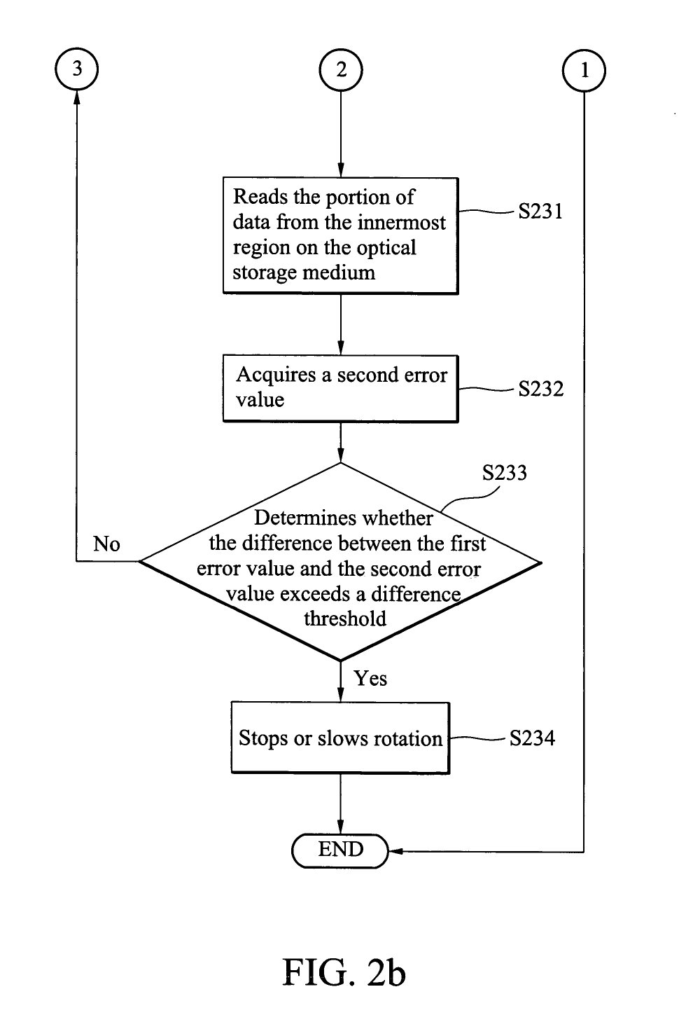

FIGS. 2a and 2b are flowcharts of a reading method according to an embodiment of the present invention. The method may be implemented in firmware or physical circuits in the reading apparatus 10. The process begins in step S211 to receive an initial signal indicating an optical storage medium is loaded. In step S212, a portion of data is read from the innermost region of the optical storage medium. In step S213, an error count is acquired for the prior reading result as a first error value. The first error value may be a random error count or a burst error count. Preferably, the random error count corresponds to a C1 value for R-S codes, and the burst error count corresponds to a C2 value for R-S codes. In addition, the first error value may be a weighted average of the random error count and the burst error count. In step S214, the process determines whether the first error value exceeds an initial threshold, and, if so, the process proceeds to step S214, otherwise, to step S221. In step S215, the process stops the reading apparatus 10 or slows rotation (preferably to a minimum rotation speed).

Steps S221 to 223 are iteratively performed for a predetermined period to detect whether the optical storage medium has produced a fissure after numerous rotations. If detected, the process stops the reading apparatus 10 or slows the rotation speed, reducing disc breakage at high rotation speeds. In step S221, the process idles for a predetermined period, for example, one minute. In step S222, the process detects whether the reading apparatus 10 is busy (e.g, reading or writing data), and, if so, the process proceeds to step S221; otherwise, the process proceeds to step S231. In step S231, the same portion of data is read as in step S212. In step S232, an error count is acquired for the prior reading result as a second error value. It is noted that the error count is the same type as that acquired in step S213. In step S233, the process determines whether the difference between the first error value and the second error value exceeds a difference threshold (preferably equaling the first error value), if so, the process proceeds to step S234; otherwise, to step S221. In step S234, the process stops the reading apparatus 10 or slows rotation (preferably to a minimum rotation speed).

An example of the method is further described as follows. If initial threshold is 300, and the difference threshold equals an acquired first error value, then, after an optical storage medium is loaded, and the process proceeds to step S212, and data from LBA 0 to 4000 on the optical storage medium is read. Referring to step S213, C1(i)=98 is acquired as a first error value, and the process continues to step S221 because the first error value lowers the initial threshold. Referring to step S221, the process idles for one minute. Given a fissure is produced in the optical storage medium due to mechanical problems, the process continues to step S231, whereby data from LBA 0 to 4000 is read again. Referring to step 232, C1(t1)=776 is acquired to be a second error value. The process continues to step S234 to slow the reading apparatus 10 to a minimum speed to reduce disc breakage because the difference between the second error value and the first error value exceeds the difference threshold.

Although the present invention has been described in its preferred embodiments, it is not intended to limit the invention to the precise embodiments disclosed herein. Those who are skilled in this technology can still make various alterations and modifications without departing from the scope and spirit of this invention. Therefore, the scope of the present invention shall be defined and protected by the following claims and their equivalents.

1. A reading apparatus comprising:
a data reading component configured to read data from an optical storage medium;
a mechanical device rotatably drive the mechanical device; and
a control unit configured to perform a first processing step and a second processing step after receiving an initial signal from the mechanical device,
wherein in the first processing step, the control unit acquires a first error value after the mechanical device reads a portion of data from an inner to an outer region on the optical storage medium, and in the second processing step, the control unit acquires a second error value after the mechanical device reads the portion of data from the optical storage medium, and adjusts rotation of the mechanical device when the difference between the first error value and the second error value exceeds a difference threshold.

2. The reading apparatus as claimed in claim 1, wherein the control unit adjusts the mechanical device by selectively stopping or slowing the mechanical device.

3. The reading apparatus as claimed in claim 1, wherein the second processing step is performed after a predetermined period of time, and when the mechanical device is idle.

4. The reading apparatus as claimed in claim 1, wherein the first error value represents a count of error codes acquired during the first processing step.

5. The reading apparatus as claimed in claim 1, wherein the second error value represents a count of error codes acquired during the second processing step.

6. The reading apparatus as claimed in claim 1, wherein both the first error value and the second error value represent a random error count or a burst error count.

7. The reading apparatus as claimed in claim 1, wherein the random error count corresponds to a C1 value for Reed-Solomon codes, and the burst error count corresponds to a C2 value for Reed-Solomon codes.

8. The reading apparatus as claimed in claim 6, wherein the control unit adjusts rotation of the mechanical device when the first error value exceeds an initial threshold.

9. The reading apparatus as claimed in claim 8, wherein the control unit adjusts the mechanical device by selectively stopping or slowing the mechanical device.

10. A reading apparatus comprising:
a data read component configured to read data from an optical storage medium;
a mechanical device rotatably drive the mechanical device; and
a control unit configured to acquire a first error value after the mechanical device reads a portion of data from an inner to an outer region on the optical storage medium, and adjust rotation speed of the mechanical device when the first error value exceeds an initial threshold.

11. The reading apparatus as claimed in claim 10, wherein the first error value represents a random error count or a burst error count.

12. The reading apparatus as claimed in claim 11, wherein the random error count corresponds to a C1 value for Reed-Solomon codes, and the burst error count corresponds to a C2 value for Reed-Solomon codes.

13. A method of reducing breakage in optical storage media at high rotation speeds in a reading apparatus, the reading apparatus comprising a mechanical device rotatably operating when the reading apparatus reads data, comprising the steps of:
receiving an initial signal from the mechanical device;
acquiring a first error value after a portion of data from an inner to an outer region on the optical storage medium is read;
acquiring a second error value after the portion of data on the optical storage medium is read; and
adjusting rotation of the mechanical device when the difference between the first error value and the second error value exceeds a difference threshold.

14. The method as claimed in claim 13, wherein the first error value and the second error value comprise a random error count or a burst error count.

15. The method as claimed in claim 14, wherein the random error count corresponds to a C1 value for Reed-Solomon codes, and the burst error count corresponds to a C2 value for Reed-Solomon codes.

16. The method as claimed in claim 13, wherein adjustment of rotation comprises stoppage or slowing of the mechanical device.

17. The method as claimed in claim 13 further comprising a step of adjusting rotation of the mechanical device when the first error value exceeds an initial threshold.

18. The method as claimed in claim 17, wherein adjustment of rotation comprises stoppage or slowing of the mechanical device.

19. The method as claimed in claim 13, wherein the second error value is acquired after a predetermined period has passed, and when the mechanical device is idle.

20. A method of reducing breakage in optical storage media at high rotation speeds in a reading apparatus, the reading apparatus comprising a mechanical device rotatably operating when the reading apparatus reads data, comprising the steps of:
receiving an initial signal from the mechanical device;
acquiring a first error value after a portion of data from an inner to an outer region on the optical storage medium is read; and
adjusting rotation of the mechanical device when the first error value exceeds an initial threshold.

21. The method as claimed in claim 20, wherein the mechanical device rotates when the reading apparatus reads data, and adjustment of rotation comprises stoppage or slowing of the mechanical device.

22. The method as claimed in claim 20, wherein the first error value comprises a random error count or a burst error count.

23. The method as claimed in claim 22, wherein the random error count corresponds to a C1 value for Reed-Solomon codes, and the burst error count corresponds to a C2 value for Reed-Solomon codes.
